(19) United States
(12) Patent Application Publication
(10) Pub. No.: US 2019/0317232 A1
(43) Pub. Date: Oct. 17, 2019

(54) HIGH-PRODUCTIVITY SEISMIC DATA ACQUISITION USING CALENDAR-TIME-BASED SWEEP INITIATION

(71) Applicant: CGG SERVICES SAS, Massy Cedex (FR)

(72) Inventors: Brice TAYART DE BORMS, Bourg-la-Reine (FR); Julien COTTON, Bourg-la-Reine (FR); Paul HARDOUIN, Viroflay (FR)

(21) Appl. No.: 15/954,976

(22) Filed: Apr. 17, 2018

(51) Int. Cl. G01V 1/00; G01V 1/09

(52) U.S. Cl. CPC G01V 1/005; G01V 1/09

(57) ABSTRACT

A method for actuating plural sets of vibratory seismic sources. The method includes calculating, at a controller, a continuous signal Cₙ that is made as a periodic repetition of a template pₙ, wherein the template pₙ includes a swept-frequency signal; receiving a subset duration time L_{sub}; receiving a tapering function W having a time length of L_{sub}; receiving a calendar time t_{sweep}; computing, at the controller, a product Sₙ of a subset of the continuous signal Cₙ and the tapering function W, wherein the subset of the continuous signal Cₙ starts at the calendar time t_{sweep} and lasts for the duration time L_{sub}; and actuating a set n of the plural sets of vibratory sources at the calendar time t_{sweep}, wherein each vibratory source of the set n of vibratory sources is actuated based on the product Sₙ.

### BACKGROUND

### Technical Field

Embodiments of the subject matter disclosed herein generally relate to methods and systems for acquiring seismic data, and more specifically, to a method for stating a sweep for a seismic source based on calendar time.

### Discussion of the Background

Land seismic data acquisition and processing may be used to generate a profile (image) of the geophysical structure under the ground (subsurface). While this profile does not provide an accurate location for oil and gas reservoirs, it suggests, to those trained in the field, the presence or absence of such reservoirs. Thus, providing a high-resolution image of the subsurface is important, for example, to those who need to determine whether the oil and gas reservoirs are located.

Geophysical prospectors generate seismic waves in order to probe the subsurface (e.g., for imaging the earth). These acoustic waves may be generated from an explosive, implosive, impulsive, or a vibratory source executing swept-frequency (chirp) or pseudo-random sequence. Recordings of the acoustic reflection and/or refraction wavefronts that travel from the source to a receiver are used to produce a seismic field record. Variations in the travel times of the reflection events in these field records indicate the position of reflection and/or refraction surfaces within the earth.

A swept-frequency or chirp type seismic source may use a long pilot signal to ensure sufficient energy is imparted to the earth. With a swept-frequency type source (also called vibratory source herein), the energy is emitted in the form of a sweep of regularly increasing (upsweep) or decreasing (downsweep) frequency in the seismic frequency range. The vibrations of the vibratory source are controlled by a control system, which can control the frequency and phase of the emitted seismic signals. These vibratory sources are low energy and, thus, this causes noise problems that may affect the recorded seismic data. For example, the vibratory source generated harmonic energy may be an additional source of energy manifesting as noise, distortion or interference with recorded data. Generally for chirps, the vibratory source emits only one frequency at a time and its harmonics, so nonlinear coupling effects in the earth will result in noise that is indistinguishable from the harmonic noise.

In order to increase the energy imparted into the ground, plural vibratory sources may be deployed and actuated simultaneously. The waves emitted by each vibrator in the set, or “fleet”, will sum in the downwards direction, which is usually the desired direction of emission to sound the subsurface of the Earth. The downgoing waves interfere constructively, resulting in a stronger signal propagating into the subsurface. In other directions, the interference will not necessary be constructive. In particular, horizontally-propagating Rayleigh waves, which carry little information regarding the deeper contents of the Earth and are usually regarded as harmful noise, may be attenuated.

Currently, for reducing the seismic survey time, multiple sets of vibratory sources are deployed at various locations. In order to complete a seismic survey, seismic waves must be emitted at multiple pre-determined locations. In order to reduce the survey time and cost, multiple sets of vibratory sources may be used concurrently. Each set alternatively moves between locations where waves are to be emitted and stops to emit seismic waves. There may also be a waiting time between the end of the movement phase and the start of the emission. Increasing the number of source sets increases the amount of time spent imparting seismic waves into the ground, and thus, the area covered by the survey in a given time. There is a strong restriction, however: a seismic wave that is received by one of the sensors can usefully contribute to the model of the subsurface that is sough, only if the source location it originates from is known. Thus, multiple sets of source would only be used insofar as the signals they emit can be distinguished one from another.

Being able to distinguishing signals emitted by plural sources is an old and well-known problem, referred to as multiplexing, with has implications in various domains such as radio transmission or radar detection. Many solutions have been developed over time for distinguishing the signals, several of which have seen an implementation in the field of seismic surveys.

Perhaps the simplest and most common method is an implementation of Time Division Multiplexing (TDM), or time sharing, colloquially known as “flip-flop” in the field of seismic. Once a set of vibratory sources has started to emit seismic waves, the other sets are not permitted to emit any signal until the first set has finished its emission, and sufficient time has passed for the waves it emitted to dissipate into the ground. It is thus certain that the seismic waves received from a certain source location will not be mixed with seismic waves from any other location. While a fleet is emitting seismic waves, the other ones move to their next location. And by the time the fleet has completed its emission and the minimum waiting time has elapsed, one of the other fleets should be in place ready to start another emission. If that fleet has arrived early at its location, then it remains idle until the time has come to start the emission. On the other hand, if no fleet has arrived, then the recording system either remains idle or records useless signals that will be discarded at a later stage.

Another common implementation of multiplexing is the slip-sweep method published by Rozemond (H. J. Rozemond, 1996, Slip-sweep acquisition, 66^{th} SEG annual meeting). It relies on all source sets using the same swept-frequency, or chirp signal. When vibratory sources are used, the process of pulse compression compresses the received signal in a way that approximates what would have been received if the source was impulsive rather than vibratory. In this case, because pulse-compressed chirps make sharp wavelets with no significant side lobes energy, and because the pulse compression is the same for all source sets, one would not expect to receive any energy once enough time has passed for the seismic waves to dissipate into the ground. It is thus sufficient to wait such time between the start of two consecutive emissions of seismic waves. Time division multiplexing is obtained after the pulse compression, regardless of the duration of the emission. This is possible because the emitted signals are actually separated in the time-frequency domain before pulse compression, and pulse compression turns this into a simple time separation. In practice, however, the sources emit some harmonics along with the fundamental frequency of the chirp. After pulse compression, the wavelet may have significant energy away from time zero and, unless some specific noise-attenuation processing is done, the recorded data is contaminated by cross-talk noise.

Other multiplexing schemes include code multiplexing, where the sets of vibratory sources emit encoded signals that are weakly correlated. Building a set of encoded sweeps relies on the use of pseudorandom sequences. Various methods proposed include: 1) Convolution of a base signal by a set of pseudo-random binary sequence, such as Gold codes or Kasami sequences; 2) Filtering of a binary sequence; 3) Random rearrangements of a reference signal; 4) Random sequences of pulses; and 5) Signals build from sequences of non-binary pseudo-random numbers, obtained from a linear or Gaussian generator. A comprehensive review of the schemes proposed is presented in “The use of pseudorandom sweeps for vibroseis surveys,” T. Dean, Geophysical Prospecting, 2014, 62, 50-74.

There are also hybrid methods such as Exxon-Mobile's HVFS™ (U.S. Pat. Nos. 5,719,821 and 5,721,710). The principle of this method is to have N sets of vibrators emitting simultaneously at least N repetitions of a swept frequency signal. For each set, the initial phase of each repetition of the sweep is chosen according to an encoding table. Provided that the signals are simultaneous and that the phase shifts are well chosen, they do not cross-correlate and the individual contribution from each set can be measured. Meanwhile, any other set beyond these N is not permitted to emit any signal. This method thus combines a code multiplexing between sets of sources vibrating simultaneously, and time multiplexing with the other sets.

There are many other implementations of the multiplexing for seismic acquisition. In recent years, the industry has even started to use unconstrained acquisition schemes, where no attempt is made to multiplex signals from different source sets. Indeed, the reflectivity of the subsurface is not random, but is expected to show some spatial regularity. With this assumption, advanced processing algorithms may seek to assign the received seismic waves to either of the source sets, so that the model derived from the measurements shows the expected spatial regularity.

In this regard, FIGS. 1A and 1B illustrate a traditional flip-flop seismic acquisition method (i.e., a method in which a source shoots first and then another source shoots second, in a flip-flop manner) in which a first set of vibrators generate seismic waves 100 during a first sweep time 110 and a second set of vibrators generate seismic waves 120 during a second sweep time 130. The second sweep time 130 starts after the end of the first sweep time 110 as illustrated in FIG. 1B. FIG. 1B shows a wait time 140 between when the first set of vibrators have finished sweeping and when the second set of vibrators start sweeping. This is wasted time for the seismic survey. FIG. 1B also shows the move time 150 that is necessary for each set of vibrators to move from one shooting location to another shooting location.

An improved shooting method is the slip-sweep method, which is illustrated in FIGS. 2A and 2B. FIG. 2A illustrates that the second set of sources 120 starts shooting while the first set of sources 100 are still shooting (i.e., the second set starts shooting with a slip time relative to the first set) while FIG. 2B shows that less waiting time 140 is now wasted during the seismic data acquisition process.

As of the date of filing this patent application, time division multiplexing schemes, whether flip-flop, slip-sweep or other, remain by far the most common method in use in the seismic industry to operate plural sets of vibratory sources. This requires of course some kind of coordination between the sets in order to maintain the time sharing, and the most common method for that is the use of a radio telemetry link connecting all source sets to a central unit in charge of the coordination.

Traditionally, the sources had to be somehow connected to the recording system for time synchronization. Indeed, the seismic sounding of the subsurface relies on the measurement of the travel time of seismic waves, and the emission and reception of seismic waves must be timed on a common reference. The discrepancy between the source and the receivers is expected to be within a small fraction of a sample interval, i.e., typically a few tens of microseconds. It is not practical to use clocks of such accuracy that the recorder and sources could remain synchronized, because even an expensive high-performance oscillator would drift beyond the required accuracy after merely several minutes. Rather than trying to use these expensive oscillators, the clock from the recording system is used as the time reference. The vibratory sources and recording system being in different locations, a telemetry link would be used to synchronize the sources' clocks with the recorder's reference. A source controller or a navigation system could trigger the sensors to start recording seismic measurements and the various vibratory sources to start emitting seismic waves, within the required accuracy.

Such telemetry link was necessary and also subject to regulatory restrictions. However, such telemetry link is difficult to maintain in areas adverse to the propagation of radio waves, such as forests, hills or cities. But since it was there, a source controller located next to the recorder could conveniently use it to coordinate the time multiplexing of the various source sets.

The advent of global navigation satellite systems provides another way of synchronization. GNSS satellites carry precision clocks and broadcast timestamps signals, from which cheap GNSS receivers can derive a position with an accuracy of a few-meters and a time with an accuracy of much less than a microsecond. With a shared time reference, it is possible to continuously record seismic timestamped measurements. When a set of seismic sources is activated, the time of the emission is recorded at the sensors by a GNSS receiver or equivalent device. At a later stage, subsets of the continuous records starting at the time of the shot are extracted.

With such systems, a telemetry link is not required for time synchronization between the sources and the sensors, as GNSS clocks are accurate enough. The flip-flop or slip-sweep acquisition schemes previously discussed may still be performed with a central unit that remotely controls the sources through the telemetry links deployed for the sole purpose of coordinating the sets. However, other implementations of the multiplexing have been sought that do not rely on a real-time coordination. With such schemes, source sets become independent one from another and it becomes possible to get rid of the radio link.

One possibility is to use a multiplexing scheme that does not rely on time, such as code division multiplexing (CDM). An interesting implementation of CDM has been described in U.S. Pat. No. 8,773,950. Each set of vibrators is assigned a continuous pseudorandom sequence designed to be weakly correlated with the other ones over a predetermined time interval. When a fleet is ready to start emitting seismic waves at a desired location, it may do so immediately. The signal emitted is a subset extracted from the continuous pseudo-random sequence, starting at the time of the start of the emission, and having a pre-determined duration. Cross-talk noise between un-coordinated emissions by several source sets can thus be much reduced. The method suffers however from some shortcomings because the pseudo random sequences, when used in seismic acquisition, 1) carry less energy, have a small bandwidth and amplitude, 2) they manifest non-linearity effects in the emission of the signal or in the coupling of the source or receivers so that the ground cannot be easily accounted for, 3) they are a source of distortion and cross-talk, and 4) some servo-controllers for hydraulic vibrators rely on a measurement of the instantaneous phase of the signal to be emitted and thus, these controllers will struggle to emit signals that cannot be represented as a sinusoidal signal.

Another possible implementation of a coordination method that does not require a real-time data link is the time-slot method for time division multiplexing described in U.S. Pat. No. 8,451,686. In this method, the source shooting is authorized for the sources at pre-determined shooting times. These authorized shooting times are chosen so that there is a minimum time between two consecutive emissions of seismic waves. The method can thus be used to implement flip-flop or slip-sweep acquisition schemes without real-time coordination. Once a fleet is ready to emit at a desired location, it will wait until its next authorized slot to start the emission. During this waiting time however, vibrator trucks, which are expensive to hire and operate, remain idle and this can significantly contributes to the cost of a seismic survey.

A side effect of this method is that the signal that a vibratory source could be emitting at any given time is known in advance. It is not known whether the source will be emitting or not the signal for the allocated time-slot because the vibratory source can fail to get in time to the supposed shooting time or it may experience other time delay problems. But if it is emitting a signal, then the signal is known. This method can be seen as assigning to each source set a continuous signal made by repeating a chirp at the authorized shooting times. The slip-sweep method works because, notwithstanding undesired harmonics, the continuous signal from the different fleets are not correlated at all within a time interval around zero.

This property of weak correlation will still hold for subsets of the continuous signals, whether or not they start at one of the authorized shooting times. This leaves room for a novel method for operating multiple fleets of vibratory sources, which does not require real-time coordination and which does not restrict the time when the sets of vibratory sources can start shooting

The time-slots method assigns to each set of vibratory sources, prior to the start of field operations, a number of time slots in which the vibratory sources are authorized to initiate the emission of seismic waves. For instance, four sets of vibratory sources could each have time slots every two minutes, with a 30 second shift between the slots of two consecutive sets. The time-slots method ensures that there is limited interference between the vibratory sources. This method was implemented by the assignee of this application for vibroseis sources (see, for example, U.S. Pat. No. 8,451,686).

### SUMMARY

According to an embodiment, there is a method for actuating plural sets of vibratory seismic sources. The method includes calculating, at a controller, a continuous signal Cₙ that is made as a periodic repetition of a template pₙ, wherein the template pₙ includes a swept-frequency signal; receiving a subset duration time L_{sub}; receiving a tapering function W having a time length of L_{sub}; receiving a calendar time t_{sweep}; computing, at the controller, a product Sₙ of a subset of the continuous signal Cₙ and the tapering function W, wherein the subset of the continuous signal Cₙ starts at the calendar time t_{sweep} and lasts for the duration time L_{sub}; and actuating a set n of the plural sets of vibratory sources at the calendar time t_{sweep}, wherein each vibratory source of the set n of vibratory sources is actuated based on the product Sₙ.

According to another embodiment, there is a controller for actuating plural sets of vibratory seismic sources. The controller includes an interface for receiving a subset duration time L_{sub}, receiving a tapering function W having a time length of L_{sub}, and receiving a calendar time t_{sweep}. The controller also includes a processor configured to calculate a continuous signal Cₙ that is made as a periodic repetition of a template pₙ, wherein the template pₙ includes a swept-frequency signal, compute a product Sₙ of a subset of the continuous signal Cₙ and the tapering function W, wherein the subset of the continuous signal Cₙ starts at the calendar time t_{sweep} and lasts for the duration time L_{sub}, and actuate a set n of the plural sets of vibratory sources at the calendar time t_{sweep}, wherein each vibratory source of the set n of vibratory sources is actuated based on the product Sₙ.

According to another exemplary embodiment, there is a non-transitory computer readable medium including computer executable instructions, wherein the instructions, when executed by a computer, implement the method discussed above.

### BRIEF DESCRIPTION OF THE DRAWINGS

For a more complete understanding of the present invention, reference is now made to the following descriptions taken in conjunction with the accompanying drawings, in which:

FIG. 1A illustrates frequencies emitted by two fleets of seismic vibrators in a flip-flop mode and FIG. 1B illustrates the waiting times associated with such a configuration;

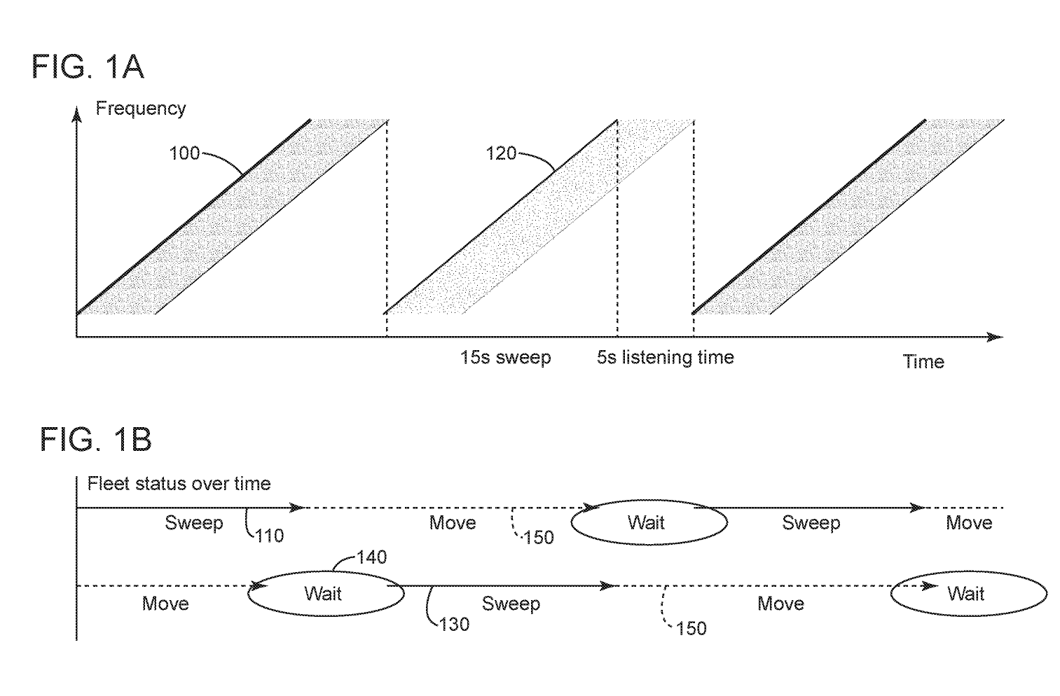

FIG. 2A illustrates frequencies emitted by two fleets of seismic vibrators in a slip-sweep mode and FIG. 2B illustrates the waiting times associated with such a configuration;

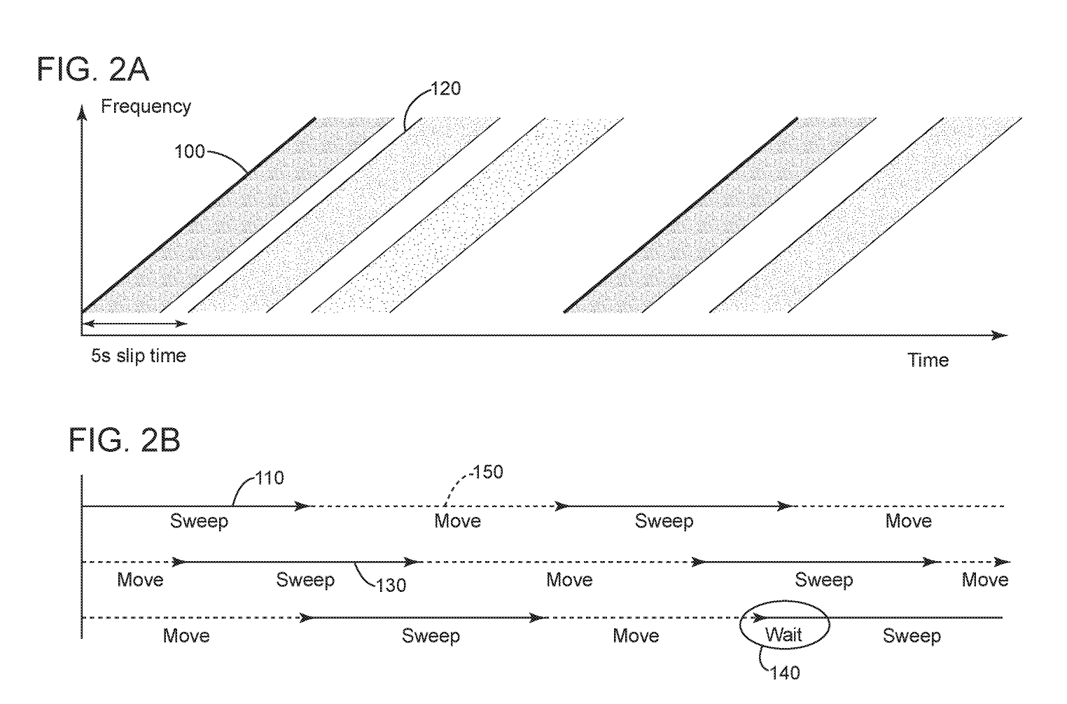

FIG. 3 illustrates a land seismic survey system;

FIG. 4 illustrates plural subsets of a mother signal that are used to drive various fleets of vibratory sources;

FIG. 5 is a flowchart of a method for calculating continuous orthogonal signals for driving plural sets of vibratory sources;

FIG. 6 illustrates the selection of a slip-time;

FIG. 7 is a flowchart of a method for driving plural sets of vibratory sources such that no fundamental energy is recorded due to any two sets for the same frequency and at the same time;

FIG. 8 illustrates a continuous signal, a taper function, and a tapered subset obtained from the continuous signal and the taper function;

FIG. 9 illustrates a sweep signal, a template, and a continuous signal formed based on the template;

FIG. 10 illustrates plural continuous signals for driving plural fleets of vibratory sources;

FIG. 11A illustrates the frequencies generated in time by a first fleet and FIG. 11B illustrates that the first fleet emits signals with no waiting time;

FIG. 12A illustrates the frequencies generated in time by a second fleet and FIG. 12B illustrates that the second fleet emits signals with no waiting time;

FIG. 13A illustrates the frequencies generated in time by a third fleet and FIG. 13B illustrates that the third fleet emits signals with no waiting time;

FIG. 14A illustrates the frequencies generated in time by all three fleets and FIG. 14B illustrates that each fleet emits signals with no waiting time;

FIG. 15 is a flowchart of a method for processing recorded seismic data; and

FIG. 16 is a schematic diagram of a controller configured to drive one or more vibratory sources.

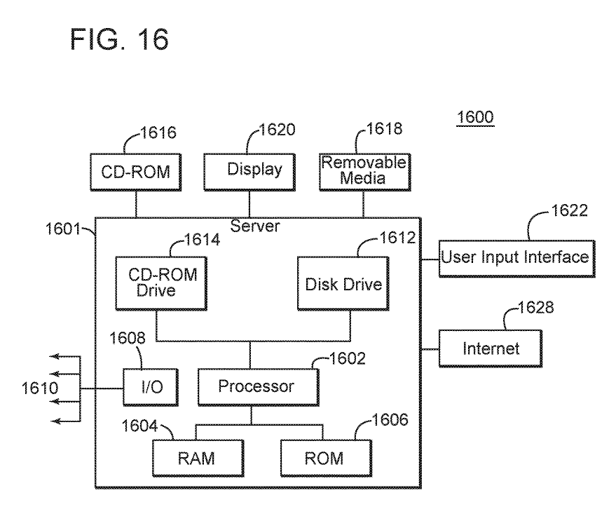

### DETAILED DESCRIPTION OF THE INVENTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a land seismic system having a set of seismic sources. However, the embodiments to be discussed next are not limited to a land seismic system, but they can be applied to a marine seismic system that uses vibratory sources.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

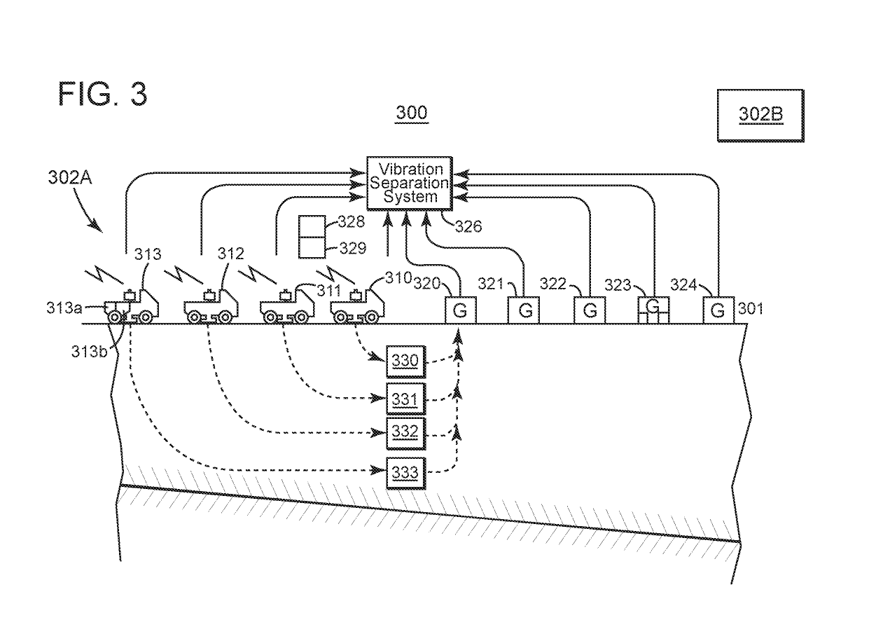

Before discussing in more detail a novel method for activating plural sets of vibratory sources, a land seismic system 300 that generates and also collects seismic data is discussed with reference to FIG. 3. The exemplary survey system 300 includes plural sets of vibrators 302A and 302B. For simplicity, only two sets of vibrators are shown in the figure but one skilled in the art would understand that any number N of sets of vibrators may be used. Also for simplicity, the second set of vibrators 302B is illustrated schematically as a box. However, the second set of vibrators 302B may have a configuration similar to the first set of vibrators 302A or may include a different number of vibratory sources.

The first set of vibrators 302A is shown in the figure including four individual vibratory sources 310, 311, 312, and 313 placed at the surface of the earth 301. Each set of vibratory sources may include the same number as the first set or a different number. Individual vibratory sources 310, 311, 312, and 313 may be conventional truck-mounted vertical P-wave vibrators; however, it is understood that other vibrators, such as horizontal shear-wave vibrators, may be utilized or even a mixture of both P-wave and shear wave vibrators. The deployment of the vibratory sources may vary widely depending upon the survey requirements. For example, for a 3-D survey the vibratory sources may be spaced far apart and not collinear with one another.

Each vibratory source may be equipped with a sweep generator module and control system electronics. For example, FIG. 3 shows vibratory source 313 having the sweep generator module 313a and the control system electronics 313b. After receiving a start command, for example, initiated via a telemetry link with the recording system or by the operator of the vibrator, each vibratory source begins sweeping. The vibratory sources of this fleet are not controlled by a central controller 329 with regard to when to start sweeping. However, in one application, the vibratory sources may be coordinated by such central controller. Each vibrator sweep generator may be loaded with a unique pilot signal. However, it is possible that each vibratory source of a given set of vibratory sources share the same pilot signal as the other elements in the set. In one embodiment, all the vibratory sources of all the sets of vibrators share the same pilot signal, but each vibratory source starts the pilot signal with different time delays, as discussed later. In one application, the vibrator sweep generator receives its corresponding pilot signal from a central controller 129 and then starts sweeping based on a calendar time.

Sensors (not shown) attached to vibrators 310, 311, 312, and 313 are connected to a vibrator separation system 326. The sensors can be motion sensors, such as accelerometers mounted to the reaction mass, the base plate of the vibrator, or the earth immediately adjacent to the vibrator, a transducer or combination of transducers configured to measure the differential pressure in the actuation chamber of the vibrator, a load cell attached to the bottom of the base plate for measurement of the ground force (contact force), or a weighted sum of the base plate and the reaction mass accelerometers useful for estimating the ground force. Additionally, the sensor could comprise strain gauges mounted on the driven structure of the vibrator to provide an estimate of the ground force. Thus, these sensors provide the ground force signals to the vibrator separation system 326.

The sensor measurement, or some filtered version of the sensor measurement, is the measured signal and represents the actual source vibration imparted to the earth by the vibrator. In this respect, it is noted that while the vibrator follows a pilot signal, the output of the vibrator (the sweep) may be different from the pilot signal. The measured signals may be transmitted to a recording system 328 by hardwired link, a radio telemetry link, or by a separate acquisition system that records and stores the measured signals so that the measured signals can be integrated with the acquired seismic data set at a later time. The recording system 328 may be implemented in the same hardware as the central controller 329, e.g., a truck or a flying device.

Receiver sensors, geophones for example, 320, 321, 322, 323, and 324 are positioned at the surface of the earth 301 (or under the surface) in the survey region at locations displaced from the vibrator position. The receiver sensors may be conventional moving coil type geophones, Micro Electro-Mechanical System (MEMS) sensor elements, or hydrophones for marine applications. In some areas, a receiver sensor may include a group of receiver sensors arranged as a receiver array to help attenuate ground roll or other noise modes. Receiver sensors are not limited to vertical component type sensors; horizontal geophones and 3-C geophones/accelerometers may also be used depending upon the nature of the survey to be conducted. For simplicity, receivers 320, 321, 322, 323, and 324 will be considered single component vertical geophones configured to function as point receivers in this embodiment.

As shown in FIG. 3, vibratory energy radiated by each vibratory source 310, 311, 312, and 313 travels through the earth from each vibrator to the receiver sensors 320, 321, 322, 323, and 324 in the survey area. The vibratory signal received by each receiver sensor will actually be a composite signal comprised of contributions from each vibratory source. Transfer functions 330, 331, 332, and 333 represent the transmission path response from vibrator 310, 311, 312, and 313 to receiver sensor 320 respectively. The transfer function will depend upon the vibratory signal radiated by each vibratory source, the refraction and reflection by the subterranean formations of the vibratory source energy, and the response of the receiver sensor. Subsequent processing steps can be used to remove the embedded response due to the choice of source measured signal and receiver response.

According to an embodiment, a seismic data acquisition system may be configured so that the sets of vibratory sources (also called VibroSeis sources) are independent from each other and do not require to be coordinated by a central unit. The vibratory sources within a same set may still be coordinated through a local telemetry link. The vibratory sources have clocks synchronized to a common time reference. Their clocks may be synchronized by the reception of a radiofrequency signal, which may be the timestamped signals broadcasted by satellites from a global navigation satellite system (GNSS). Such radiofrequency signal may also be a timing signal from any clock used as a reference, broadcasted through a radio telemetry link.

The vibratory sources may receive an emission time, upon which they may start emitting their seismic signal. The emission time may be received through a telemetry link, e.g. a “master” source broadcasting to other “slave” sources of the same set the time of the next emission, though a local telemetry link such as a WiFi network. The emission time may also be received as a pre-determined delay from receiving a triggering event. This event may be the vibrator operator pressing a button. It may be the reception of a pre-determined trigger signal over a telemetry link. I may be the actuation of a sensor, such as a pressure sensor detecting that the “shaker” assembly of the vibratory source is coupled with the earth. The emission time may also be the earliest of a set of pre-determined authorized emission times that follows the reception of a triggering event.

The vibratory sources can start emitting their seismic signal at a received time. There is no constraint on this time; in particular, the emission time may be chosen to be as close as possible to the moment when a source set is in position and ready to shoot, without having to wait for any reason. According to this embodiment, each vibratory source will select the signal to be emitted based on the calendar time at the beginning of the emission. In one application, regardless of the starting time of the emission, the pilot signals used by the various vibratory sources are calculated in such a manner that the emitted seismic signals are separated in the time-frequency domain so that they do not interfere with each other, and thus the seismic records are free of cross-talk noise.

These capabilities can be achieved by assigning to each of N sets of vibrators an infinite length “mother signal” made of the periodic repetition of a basic template. The basic template can be made of a “sweep” (swept frequency signal) that may be concatenated with a waiting period. These continuous signals are then time-shifted for each set of vibratory sources in order to respect the slip-sweep assumption that two sets of vibratory sources shall never emit the same fundamental frequency within a period less than the desired record length.

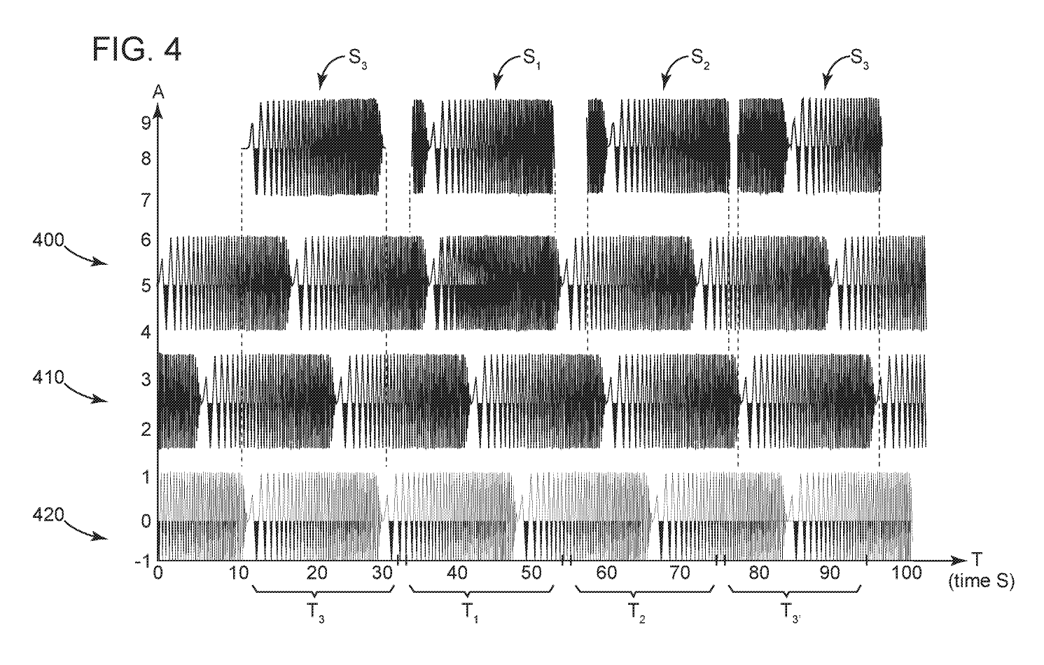

This novel idea is illustrated in FIG. 4. FIG. 4 shows a first mother signal 400 selected for a first set of vibratory sources, a second mother signal 410 selected for a second set of vibratory sources, and a third mother signal 420 selected for a third set of vibratory sources. In this example, only three sets of vibratory sources are used and they are assigned the same sweep. More or less sets of vibratory sources may be used by using the same principle. The sets of vibratory sources may use mother signals built from different swept frequency signals. In this embodiment, the second mother signal 410 is identical to the first mother signal 400 (in terms of frequency, amplitude and frequency spectrum), but time shifted with a given time interval Ati (e.g., the record length L_{R}, which is the duration of the seismic record after correlation), and the third mother signal 420 is also identical to the first mother signal 400, but time shifted with double the given time interval Ati. The first set of vibratory sources can start shooting whenever the vibratory sources are ready, using the first mother signal 400 as the pilot signal. FIG. 4 shows the first set of vibratory sources sweeping with a subset S1 of the first mother signal 400 for a time period T1. The second set of vibratory sources is shown in the figure sweeping with a subset S2 of the second mother signal 410 for a time period T2. The third set of vibratory sources is shown sweeping with a subset S3 of the third mother signal 420 for a time period T3 and a second time period T3′. Note that none of the set of vibrators had to wait. As soon as one set i of vibratory sources is in position and ready to sweep, that set of vibratory sources uses the assigned mother signal and starts sweeping at a time that corresponds to the calendar time (i.e., the current time of the day) for that mother signal for the corresponding time interval Ti. Note that the term “calendar time” in this application means the time elapsed since a common time reference, also called epoch (i.e., some date and time which is set as t=0). The time reference is arbitrary, provided that the vibratory source sets use the same epoch. The epoch could be the start of the day, or any arbitrary date e.g., Jan. 1, 1970 like for the UNIX operating system or Jan. 6, 1980 for the GPS systems.

The mother signals 400, 410 and 420 are time delayed relative to each other in such a way that a correlation of any subset S1 of the first set with any subset S2 of the second set, or any subset S1 of the first set with any subset S3 of the third set, or any subset S2 of the second set with any subset S3 of the third set do not emit a fundamental energy (i.e., energy that corresponds to a fundamental frequency) at the same frequency with a time separation smaller than the record length L_{R}, and thus, the energy recorded by the seismic sensors will not be contaminated by the fundamental energy from other shots. The harmonic noise contamination is the same as with the slip-sweep method and can be removed with similar tools as those already known.

Thus, according to this method, none of the sets (or fleets) of vibratory sources has to wait for their turn as in the traditional methods and they can start emitting energy as soon as they are ready at their shot locations, which improves the productivity of the seismic acquisition system. Further, this method does not need a centralized synchronization system as each set of vibratory sources independently decides when to start generating the seismic energy and the method can be implemented on autonomous VibroSeis sources.

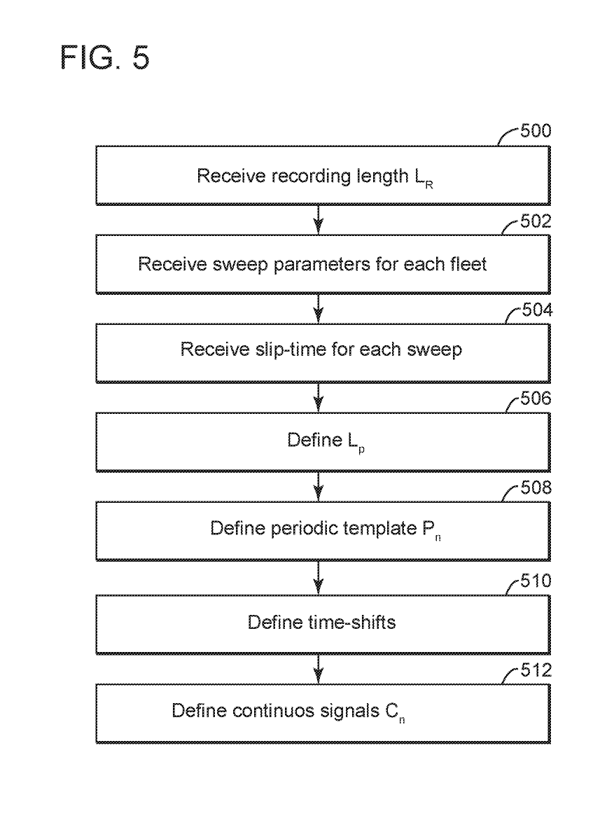

The construction of a mother signal is now discussed with regard to FIG. 5. In step 500, a recording length L_{R} is received. In step 502, the sweep parameters for each set of the N sets of vibratory sources is received. A corresponding sweep signal sₙ is then calculated based on the sweep parameters. A signal used to drive a vibratory source is a swept frequency signal (sweep) having a given duration, a start frequency fₛ, an end frequency fₑ, a frequency variation over time (“sweep rate”), and an amplitude A over time, which are chosen so that the amplitude spectrum of the emitted signal will match a desired target. These are the sweep parameters of the sweep signal. In this respect, note that each seismic survey has a desired amplitude spectrum target which is determined (based on various criteria) by the operator of the survey.

For instance, a sweep signal s may be a linear sweep given by:

$$s ( t ) = A \cdot Tap ( t ) \cdot cos ( 2 π \cdot ( \frac{{f}_{e} - {f}_{s}}{2 {L}_{sw}} \cdot {t}^{2} + {f}_{s} \cdot t ) + {ϕ}_{0} ) \qquad ( 1 )$$

where A is the amplitude (e.g., 70% of the vibrator source peak force), Tap is a taper function designed to alleviate the Gibbs phenomenon in the amplitude spectrum (e.g. a Hann taper of Blackmann taper), fₛ and fₑ are the start and end frequencies, respectively, L_{sw} is the duration of the sweep and φ₀ is the initial phase.

Because in this embodiment there are N fleets of vibratory sources, the sweep s discussed above is now defined for each fleet n of the N fleets. Thus, a sweep sₙ may be defined by its duration L_{SWn}, amplitude profile Aₙ(t), the taper function Tapₙ(t) similar to the one discussed above, the initial phase φₙ and the frequency profile fₙ(t). Those skilled in the art would know that any frequency profile f(t) having any amplitude profile A(t) may be used to drive a vibratory source. The instantaneous frequency of a sinusoidal signal is the derivative of its instantaneous phase. Thus, the instantaneous phase ϕₙ may be obtained by integration over time of the frequency, as noted in equation (2)

ϕₙ=φₙ+2π∫₀^{t}ƒ(u)du (2)

where u is a variable that varies between zero and t.

The swept frequency signal sₙ, of duration L_{swn}, is then defined as:

sₙ(t)=Aₙ(t)·Tapₙ(t)·cos(ϕₙ(t)). (3)

where t varies between zero and L_{SWn}.

To produce a seismic record of length L_{R}, the echoes of the seismic waves reflected on underground geological bodies are traditionally recorded during a listening time L_{sw}+L_{R}. This raw record of seismic data may then be correlated with the source signal sₙ (equation (3)), which yields a correlated record of duration L_{R}, which approximates the earth reflectivity r. Those skilled in the art will know that other methods can also be used to derive an approximation of earth reflectivity from the uncorrelated records, such as a deconvolution of the raw seismic record by the source signature.

Next, in step 504, a slip-time Tslipₙ is received or determined for each sweep signal. The slip-time should guarantee enough separation between any two sweeps in the time-frequency domain to preclude interferences, should sweep sₙ₊₁ be emitted after sₙ with a delay Tslipₙ. For this purpose, the separation in time between the two sweeps should be large enough that, for any frequency emitted by sweep sₙ, the same frequency is emitted by sweep sₙ₊₁ only after a delay equal to the recording time L_{R} has passed. This condition can be mathematically expressed as:

∀n<N−1, ∀t∈[0,L_{SW}_{ₙ}], ∀u such that ƒₙ(t)=ƒₙ₊₁(u), u+Tₛₗᵢₚ_{ₙ}>t+L_{R} (4),

where n is a given fleet, N is the total number of fleets, t is a current time, and u is the time at which the sₙ₊₁ sweep starts. For the last sweep s_{N}, the condition of equation (4) should hold with respect to the first sweep si, as follows:

∀t∈[0,L_{SW}_{_{N}}], ∀u such that ƒ_{N}(t)=ƒ₁(u), u+Tₛₗᵢₚ_{_{N}}>t+L_{R} (5).

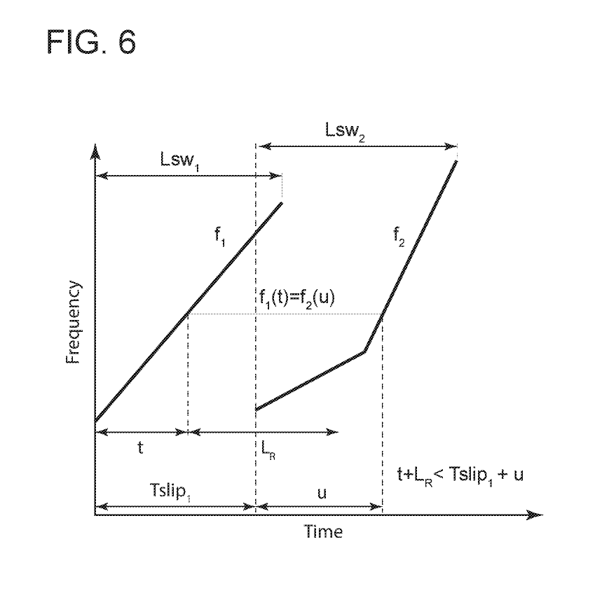

An illustration of the above conditions is shown in FIG. 6, for two sweeps of arbitrary length and frequency profile. The two sweeps are described by different functions f₁ and f₂. Tslipₙ may be chosen as the smallest value that satisfies this condition, but a larger value can be chosen for various reasons such as limiting interference from low order harmonics, leaving time for some trapped waves to dissipate, etc.

In one application, where all the sweeps follow the same frequency profile, condition (4) becomes Tslipₙ>L_{R}.

In step 506, a time period (or subset duration) L_{P} is defined. Continuous signals Cₙ, for each fleet n, are generated as periodic repetitions of templates pₙ, (to be discussed next), which share the same time period L_{P}. This period L_{P} is defined as:

$${L}_{P} = {\sum }_{n = 1}^{N} {T}_{{slip}_{n}} . \qquad ( 6 )$$

The slip-times Tslipₙ should be large enough that L_{P} is larger than the longest sweep, i.e., L_{P}>L_{SWn}. If this is not the case, one or several slip-times should be increased until this condition is met.

In step 508, the periodic templates pₙ are defined. Each continuous signal Cₙ is made of periodic repetitions of a corresponding template pₙ of time length L_{P}. A template pₙ is made by taking a corresponding sweep sₙ and padding it with zeros until it reaches the length L_{P}. If a sweep sₙ has exactly the length L_{P}, then no padding is necessary. Thus, the template pₙ is defined as follows:

$${p}_{n} ( t ) = \{ \begin{matrix}{s}_{n} ( t ) & if t \leq {L}_{{SW}_{n}} \\ 0 & if {L}_{{SW}_{n}} < t \leq {L}_{P}\end{matrix} . \qquad ( 7 )$$

In step 510, time-shifts r, are defined. Each continuous signal Cₙ is shifted in time by Tslipₙ₋₁ with respect to the previous continuous signal Cₙ₋₁. Each signal has thus a time-shift τₙ with respect to the first signal C₁, where:

$${τ}_{1} = 0 and {τ}_{n} = {\sum }_{i = 1}^{n - 1} {T}_{{slip}_{i}} . \qquad ( 8 )$$

Note that equation (8) is different from equation (7) as the sum in equation (8) extends to n−1 (the previous shot fleet) while the sum in equation (7) extends to all N fleets.

In step 512, the continuous signals Cₙ are calculated by applying the time-shift τₙ to corresponding template pₙ, as follows

$${C}_{n} ( t ) = {p}_{n} ( t - {τ}_{n} - {L}_{P} \cdot floor ( \frac{t - {τ}_{n}}{{L}_{p}} ) ) , \qquad ( 9 )$$

where the function “floor” returns the largest integer that is smaller than the argument of the function, which is a real number.

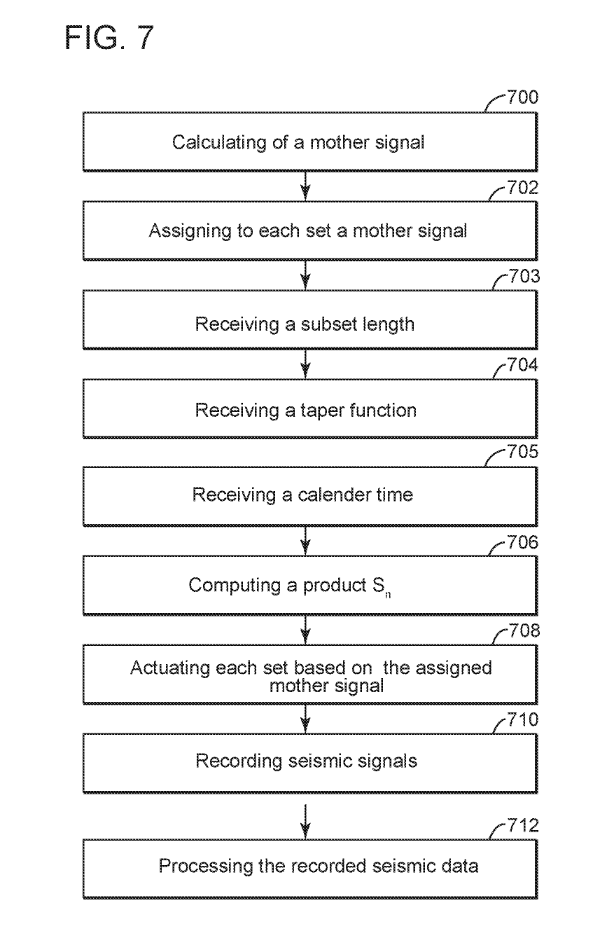

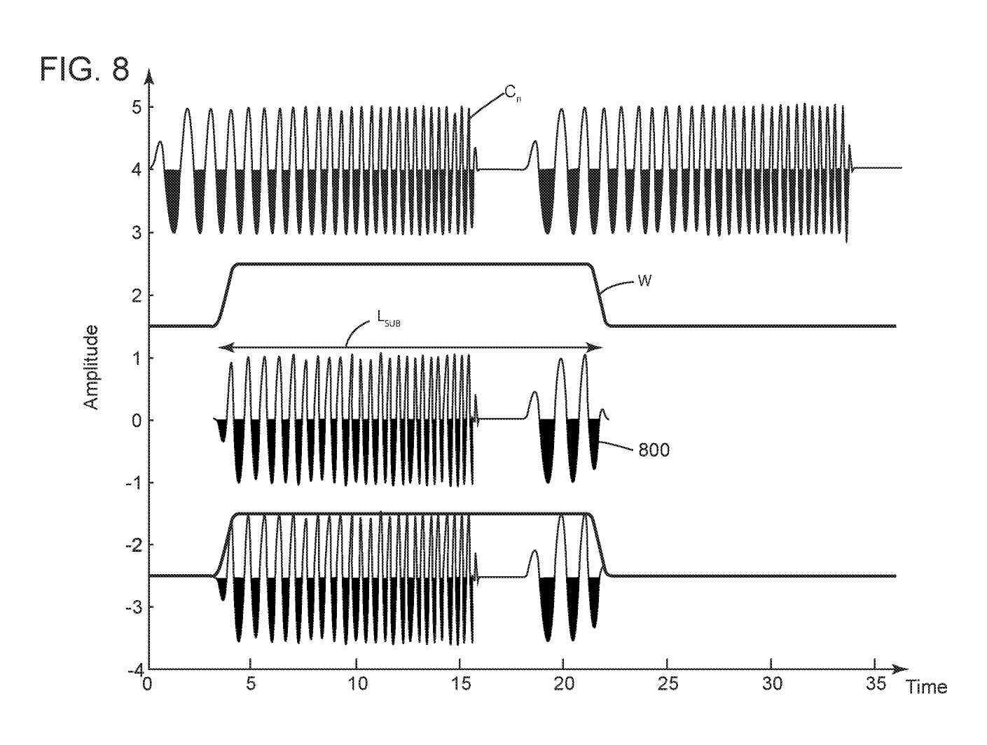

According to an embodiment, a method for actuating a vibratory source or a set of vibratory sources, based on a continuous signal Cₙ defined as discussed above with regard to FIG. 5 is now discussed with regard to FIG. 7. FIG. 7 shows the method including a step 700 in which a record length L_{R}, a set of swept frequency signals sₙ of length Lswₙ and frequency profile fₙ and a set of slip-times Tslipₙ are defined or received as discussed above. The method further includes a step 702 of assigning to each set (n) of vibratory sources (i) a corresponding mother signal (Cₙ), i.e., an infinite length signal. The corresponding mother signal Cₙ may be calculated in step 700. The mother signal may be made as a periodic repetition of a template pₙ, which includes a swept-frequency signal. Note that each set of vibratory sources may have a different mother signal Cₙ or the same mother signal, but time delayed with a different time value (Δtᵢ). A subset length L_{sub} of the corresponding mother signal Cₙ is selected or received in step 703 that is greater than L_{P}. The subset length could be slightly longer than L_{P} in order to provide some overlap in frequency, but could be even longer. For instance, a subset slightly longer than 3L_{P} would simulate the repetition of 3 sweeps. A taper function W of length L_{sub} may also be selected or received in step 704. FIG. 8 shows the continuous signal Cn, the taper function W, and the tapered subset 800.

The method further includes a step 705 of receiving a calendar time t_{sweep} of the emission, which may be determined by the operator of the survey or automatically determined by a controller based on, for example, on a pressure switch that detects that the plate of the land source is down, or determined by a computer program communicating with the various sources of the set to check whether all the sources in the set are ready. The method further includes a step 706 of computing, at a controller, a product Sn of a subset of the continuous signal Cn and the tapering function W, where the subset of the continuous signal Cn starts at the calendar time t_{sweep} and lasts for the duration time L_{sub}. The method further includes a step 708 of actuating each set of vibratory sources as soon as the vibratory sources are in position, with no waiting time. In other words, this step actuates each vibratory seismic source (i) of a given fleet (n) at a calendar time t_{sweep}, independent of (1) pre-assigned times, (2) pre-assigned time slots, and/or (3) a waiting time as in the traditional methods. Each vibratory source is actuated based on the product Sn, which is chosen based on the calendar time t_{sweep}.

This means that the vibratory sources are actuated at the current time (also called calendar time) with no need to wait for a time-slot or a correct timing. Based on the calendar time at which the vibratory source or set of vibratory sources start to emit the seismic signals, a controller (local controller for the vibratory source or a global controller for the fleet to which the vibratory source belongs) calculates the correct sub-set of the mother signal Cₙ that should be followed by each source. Each set of vibratory sources follows the assigned mother signal (note that the set of vibratory sources may emit a subset of its continuous mother signal Cₙ, the subset having a length L_{SW}+τ where τ is some small overlap time and the subset may be multiplied by the taper function W). The time at which the vibratory sources of a given set n are actuated, the time sweep t_{sweep}, may be delayed with a fixed delay (e.g., 500 ms from the reception of the instructions to shoot) or the first of a predefined time-slot, e.g., every two seconds. In another application, the fleet receives an order (instructions) to initiate a sweep at a given time t_{sweep}. This time could be immediate, with a fixed delay from the reception of the order, or at a given time based on a shared time reference. The calendar time for the initiation of the sweep is calculated according to the time reference noted above.

The sources are actuated in step 708, at the calendar time t_{sweep}, and they emit seismic waves for the subset time interval L_{sub} 800 of the continuous signal Cₙ. Because L_{sub} is longer than L_{P}, some frequencies will be emitted twice or more. This overlap ensures that at least as much energy as the initial sweep sₙ is emitted once the subset has been tapered by taper W as illustrated in FIG. 8. All vibratory sources in fleet n are actuated at the calendar time t_{sweep} with the subset L_{sub} 800.

The method further includes a step 710 of recording with the seismic sensors the seismic signals generated by the vibratory sources. These seismic signals are reflected from the subsurface. The seismic signals may either be recorded each time a vibratory source starts vibrating, or recorded continuously with the time of the shots saved for further extraction of the data from the continuous records). After this step, the method performs a step 712 of processing the recorded raw seismic data. This step may process the raw seismic data by correlation, deconvolution or a two-step correlation to get an approximation of the earth reflectivity.

The mother signal Cₙ used for driving the set n of vibratory sources may have the following properties. In one application, any tapered subset of length L_{sw} of the mother signal Cₙ has an amplitude spectrum that approximates the target spectrum. In the same application or another application, the cross-correlation of two tapered subsets of length L_{sw}, taken at any time for two different mother signals Cₙ and Cₘ (corresponding to fleets n and m, respectively) carries no meaningful energy in the [0 L_{R}] time window. This condition ensures that there is minimal interference from two different fleets.

These features are now discussed in the context of a practical example. One possible implementation of a mother signal is to start with a recording length L_{R} and a set of N monotonously-swept-frequency signal sₙ(t) of length L_{SWn} with a frequency profile fₙ(t), each assigned to one of the vibrator sets. As an example, the record length could be 5 seconds. All fleets could be assigned a 8-80 Hz linear sweep of 16s length with 250 ms Hann tapers and zero initial phase, as defined in equation (1), but nonlinear sweeps can also be used. Different sets could also use different sweeps with different length, frequency profiles, amplitude profiles or initial phase.

A set of N times Tslipₙ is then chosen as discussed in step 708 of the method illustrated in FIG. 7. These slip-times are durations that separate the start of the emission of two sweeps, such that the slip-sweep assumptions are honored. The slip time should guarantee enough separation in the time-frequency domain to preclude interferences, should sweep sₙ₊₁ be emitted after sₙ with a delay Tslipₙ. For this purpose, the separation in time between the two sweeps should be large enough that, for any frequency emitted by sweep sₙ, the same frequency is emitted by sweep sₙ₊₁ only after a delay equal to the recording time L_{R} has passed.

The slip-times Tslipₙ may be chosen arbitrarily provided that they meet the condition above. They may be the same but do not have to. They may be the smallest values that meet the condition, but they may be larger for various reasons, such as limiting the interference between shots from low order harmonics, leaving time for some trapped seismic waves to dissipate into the ground, etc. As it will be apparent to those skilled in the art, the choice of the slip-time is subject to the same compromise as in the traditional slip-sweep method.

Each mother signal Cₙ would be made of the continuous, periodic repetition of the template pₙ. The period L_{P} is common to all the source set and defined as the sum of the slip times: L_{P}=Tslip₁+Tslip₂+ . . . +Tslip_{N}. This period should be at least as long as the longest sweep. If this is not the case, one or several of the slip-times should be increased until the condition is met.

As an example, with three fleets using a 8-80 Hz linear sweep of 16s length, three equal slip-times of 6s could be used. In this case, the mother signal would be 18 seconds, which is longer than the duration of the sweeps.

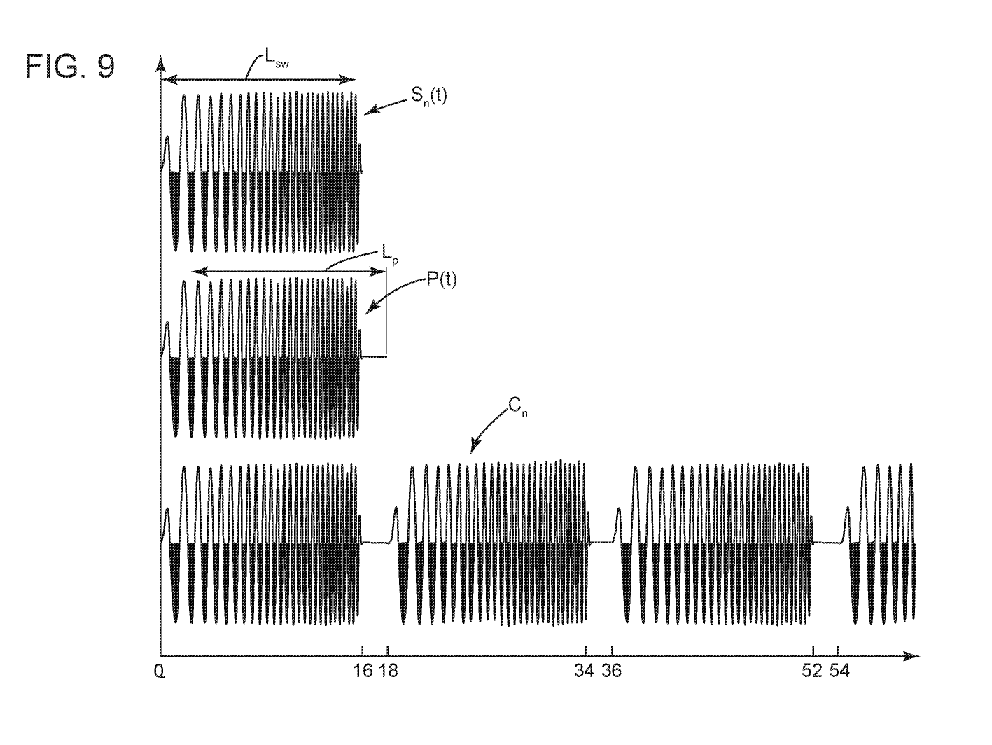

For each vibratory source set, the periodic template pₙ(t) of duration L_{P} is then defined as follow. This template would be used, as discussed later, to generate the mother signal for each set of vibratory sources. The periodic template p(t) is shown in FIG. 9 and depends on time t, which is a current time. An amplitude A of the periodic template p(t) is also shown in FIG. 9. For example, time T1 can be 18s. Other values may be used.

The template p(t) is obtained by taking the sweep sₙ and padding it with zeros until it reaches the length L_{P}. For any time t smaller than Lswₙ, pₙ(t)=sₙ(t). For any time t larger than Lswₙ, but smaller than L_{P}, pₙ(t)=0. As an example, the periodic template could be the concatenation of a 16s long, 8-80 Hz linear sweep and a 2s taper time.

Each of the continuous mother signal Cₙ is then time-shifted with respect to the previous one. The start of the continuous signal Cᵢ₊₁ is shifted by the slip-time Tslipᵢ with respect to the previous mother signal Cᵢ. The partial summation of the slip-times gives the time-shift τᵢ of signal Cᵢ with respect to the first mother signal C₁ as discussed above with regard to equation (8).

Based on the templates pₙ(t) defined above (see equation (7)), a set of n continuous signals Cₙ(t) can be defined, where Cₙ is the periodic repetition of signal pₙ, starting from time t=τₙ, (see equation (9) above). These signals can be assigned to the set of vibratory sources so that each set of the vibratory sources receives one of these signals, i.e., set “i” receives signal Cᵢ(t).

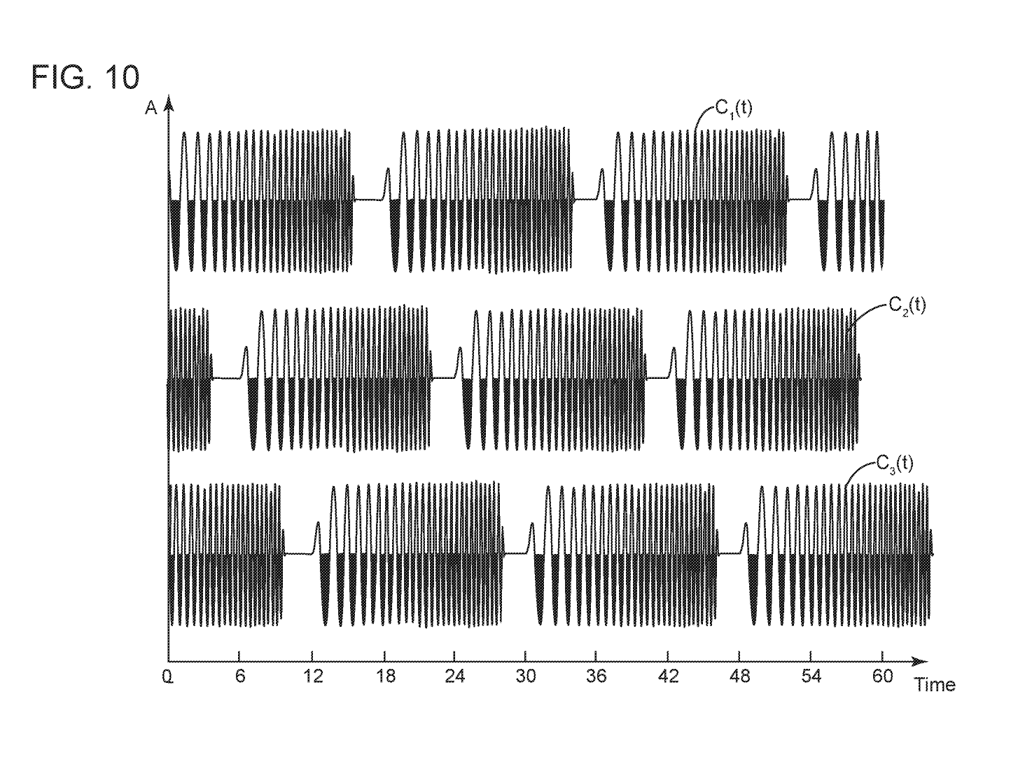

If N is considered to be 3, then C₁(t) is shown in FIG. 10 as being the mother signal for set no. 1 of the vibratory sources, C₂(t) is shown in FIG. 10 as being the mother signal for set no. 2 of the vibratory sources, and C₃(t) is shown in FIG. 10 as being the mother signal for set no. 3 of the vibratory sources.

Returning to FIG. 4, it is now clear how the sets of vibratory sources start emitting the seismic signals at any calendar time and why the subsets S1 to S3 do not start with the same amplitude as the pattern p(t). In this respect, because each set of vibratory sources starts to generate the seismic signals at any calendar time, the set of vibratory sources has to sometime start in the middle of the pattern p(t), as shown in FIG. 4 by subset S1. Subset S1 starts emitting high frequencies corresponding to the beginning of time interval T1, until all the high frequencies have been emitted. Then, the set of sources proceeds with the small frequencies and sweeps them until arriving again at the large frequencies, at which time the vibratory sources stop and move to a new location.

An example of implementing this scheme is now discussed assuming that there are 3 fleets, a record length L_{R} is 6s and a mother signal is generated by the periodic repetition of a 18s long pattern p(t), that emits a 8-80 Hz linear sweep over 16 seconds (4.5 Hz/s sweep rate) then waits for 2 seconds, starting at midnight for fleet 1, at midnight+6s for fleet 2, and at midnight+12s for fleet 3.

If fleet no. 1 is ready at midnight+100s, the 100s can be written as 5*18s+10 s where 18s is L_{P}. This means that fleet no. 1 starts at t=10s. For this application, fleet no. 1 emits a 19s signal (the 18s sweep plus is for the taper part) made of a 6s long, 53-80 Hz sweep immediately followed by a 2 seconds pause, then a 11 s long, 8-57.5 Hz sweep. Some energy is emitted in the 43-57.5 Hz band at the beginning and at the end; this ensures that, despite the presence of a taper, at least as much energy has been emitted in this band as it would have been the case with the standard 16s 8-80 Hz sweep used as a template.

If fleet no. 2 is ready to shoot at midnight+100s (=6s+5*18s+4s), the fleet will start emitting a 19s signal made of a 12s long, 26-80 Hz sweep immediately followed 2 seconds pause and by a 5s long, 8-30.5 Hz sweep.

If fleet no. 3 is ready to shot at midnight+106s (=12s+5*18s+4s), the fleet will start emitting the same signal as fleet no. 2 above because it would also start its emission 4 seconds into the periodic template.

This scheme guarantees that any two fleets of vibratory sources will not emit fundamental energy at the same frequency with a time separation smaller than the record length, and thus, the seismic recorded data will not be contaminated by the fundamental energy from the other shots.

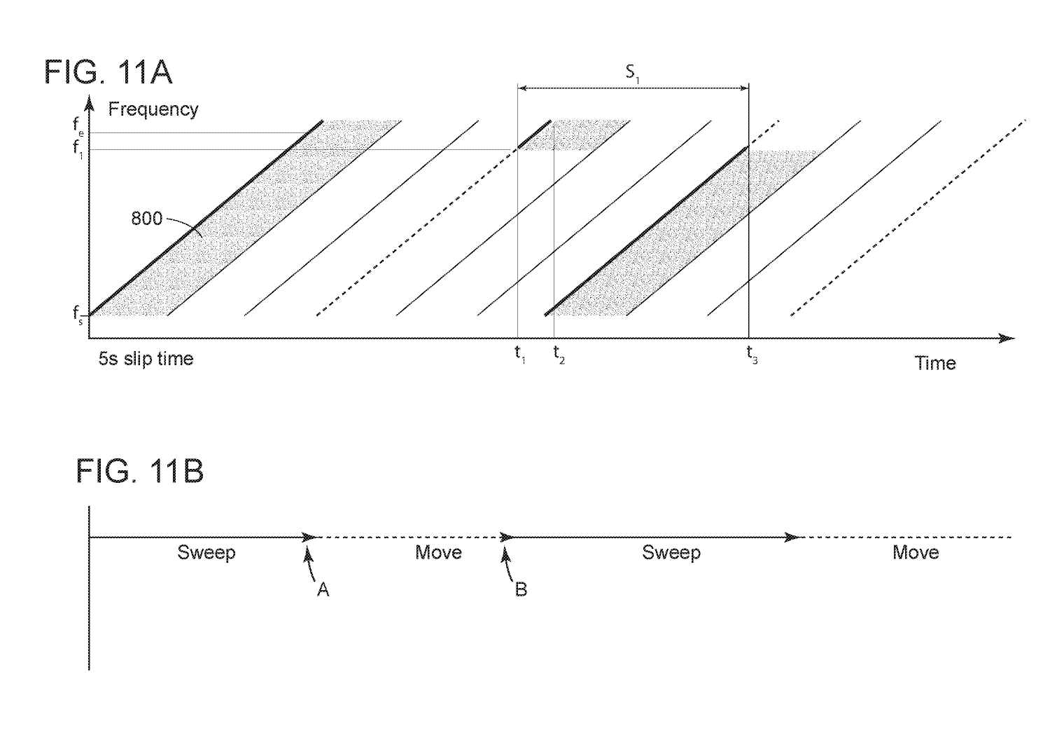

Another way to visualize this embodiment is now discussed with regard to FIGS. 11A to 14B. Assume that there are three fleets of vibratory sources. FIG. 11B shows how the first fleet of vibratory sources moves from a location A to a location B and starts sweeping immediately based on the calendar time. The sweep used by the first fleet starts at time t1, which is the calendar time (see FIG. 11A). Thus, there are no slot times or waiting periods. Based on the calendar time t1, a processor at each vibratory source determines the subset S1 to be used for vibrating the source. In the instant case, one would note that the subset starts to emit the high frequencies f₁ to fₑ until a time t2, after which the vibrator emits the low frequencies fₛ to f₁ until time t3. The time interval t3-t1 is equal to the duration L_{P} of the pattern p(t). Note that the starting frequency f₁ for sweeping for each vibratory source of the first fleet is associated with the calendar time t1 and each vibratory source performs a full sweep L_{SW} before moving to a new location. FIG. 11B shows how the first fleet moves from one shooting point to another and how the sweeping operations start at any calendar time, with no waiting time.

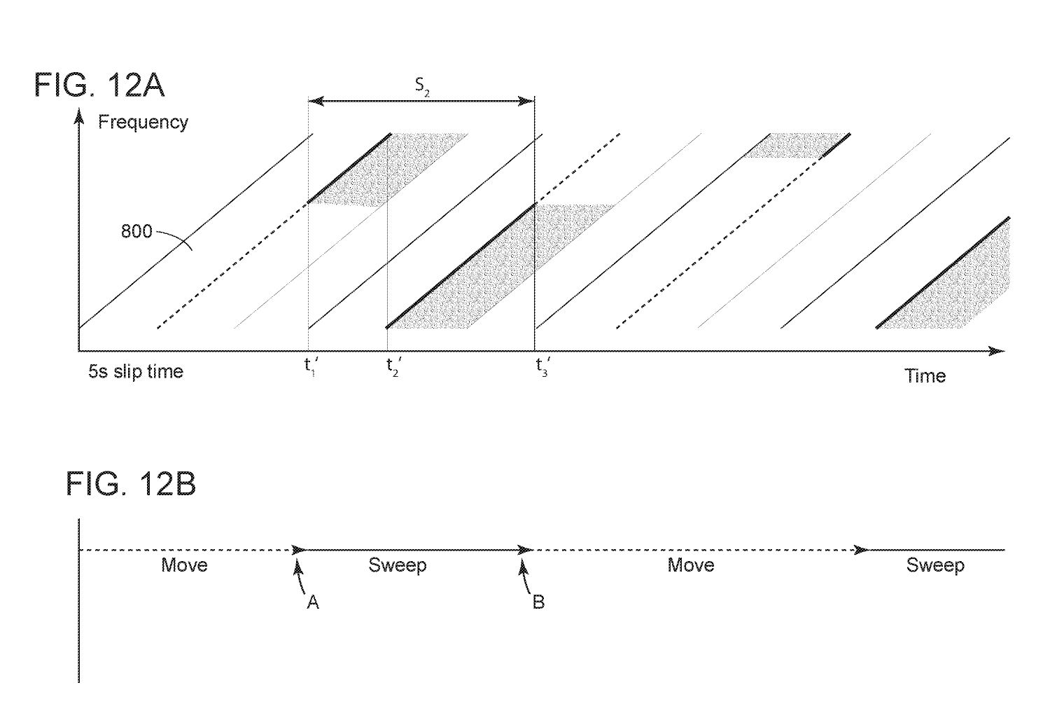

FIG. 12A shows that the second fleet starts at calendar time t1′ to emit seismic signals of high frequencies for a time interval t2′-t1′ (which is different from t2-t1 for the first fleet) and then emits low frequencies for a time interval t3′-t2′. Again, the total time interval t3′-t1′ is equal to the sweep time L_{SW} of the pattern p(t) and the second fleet starts the subset S2 at any calendar time (t1′ in this case). There is no correlation between the starting time t1 of the first fleet and the starting time t1′ of the second fleet. Irrespective of the value of the calendar time at which the fleet starts generating the seismic signals, the total length of the subset S2 is the same, only the initial point of the subset in terms of frequencies is different. FIG. 12B shows how the second fleet moves from one shooting point to another and how the sweeping operations start at any calendar time, with no waiting.

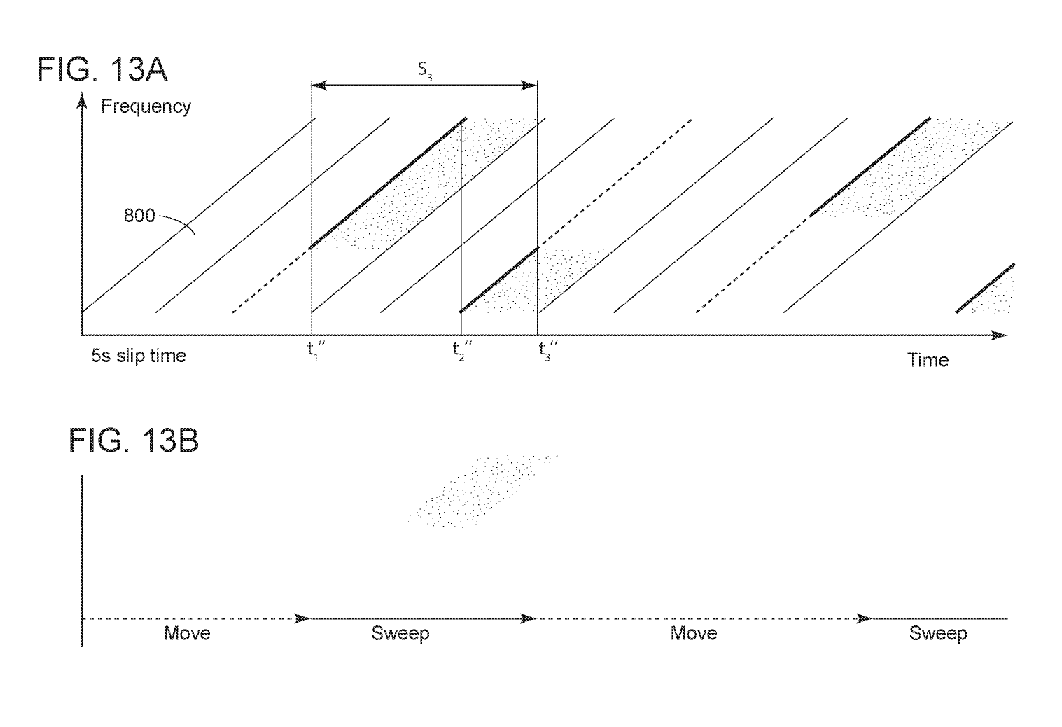

FIG. 13A shows the third fleet starting to emit the seismic signals at calendar time t1″. The third fleet emits the subset S3. It is noted that the third subset has the same length as the first and second subsets S1 and S2 of the first and second fleets. It is also noted that each subset starts at another frequency but overall, each subset includes all the frequencies of the pattern pₙ(t). This is so because the initial frequency emitted for a subset is dictated by the calendar time when the fleet starts generating the seismic signals. It is possible that, by coincidence, the calendar time when a fleet starts to emit the seismic signals corresponds to time t=0, which is the beginning of the pattern pₙ(t). If this is the case, that subset would be as shown in FIG. 11A by reference number 800, which starts at the start frequency fₛ and ends at end frequency fₑ (which were defined in equation (1)).

However, under normal operating conditions, a fleet starts at a calendar time t1, which means that the fleet first generates the frequency f1 and the following frequencies in the sweep up to fₑ, after which the fleet generates frequency fₛ and all the frequencies between fₛ and f₁, as illustrated in FIG. 11A by the subset S1. Irrespective of the starting calendar time t1, the fleet generates all the frequencies in the sweep (i.e., all the frequencies between fₛ and fₑ, including fₛ and fₑ). This is so for each fleet in the seismic survey. FIG. 13B shows how the second fleet moves from one shooting point to another and how the sweeping operations start at any calendar time, with no waiting.

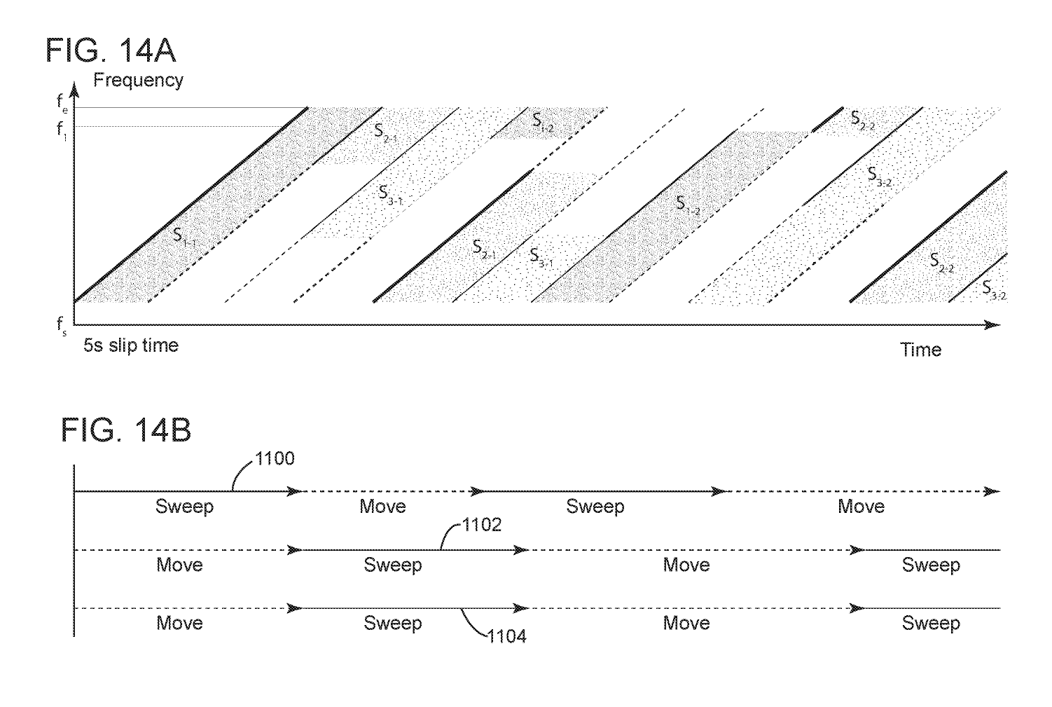

The subsets S1, S2, and S3 of the three fleets considered in FIGS. 11A to 13B are simultaneously shown in FIGS. 14A and 14B. FIG. 14A shows subset S1 being emitted for the first time (S₁₋₁) by the first fleet 1100 and the subset S1 being emitted for the second time (S₁₋₂) by the same first fleet 1100, at a different location. Note that the first subset emitted for the first time S₁₋₁ starts with the start frequency fₛ but the first subset emitted for the second time S₁₋₂ starts with the frequency f₁ discussed with regard to FIG. 11A. Similar situations can be observed for the second fleet 1102, which is shown in FIG. 14A emitting a second subset S2 for a first time S₂₋₁ and for a second time S₂₋₂, each starting at different calendar times and with different initial frequencies. FIG. 14A also shows the third fleet 1104 emitting a third subset S3 for a first time S₃₋₁ and for a second time S₃₋₂, each starting at different calendar times and with different initial frequencies. Note that there is a correlation between the calendar time and the initial starting frequency and for a linear sweep as shown in FIG. 14A, once the calendar time is selected, the corresponding starting frequency can be inferred from the linear relationship between frequency and time. Also note that there is no correlation between the initial starting times of the various fleets.

Any subset of length L_{P} of the continuous signal Cₙ contains all the frequencies of sweep sₙ. However, this subset should be tapered for the same spectral-shaping reason that required the sweep sₙ to be tapered. The application of a tapering function will attenuate the signal in the tapered part, and some frequencies of a tapered subset of length L_{P} would be strongly attenuated compared to the initial sweep sₙ. The same would not necessarily be true of a slightly longer sweep, as some frequencies would be emitted twice: once at the beginning of the sweep, and once at the end. If the subset is long enough, despite the attenuation due to the tapering, the slightly longer tapered subset would contain at least as much energy as the sweep sₙ.

A tapered subset slightly longer than k times the period L_{P} would likewise contain as much energy as k repetitions of sweep sₙ. It could be used as a replacement for emitting k times the original sweep, as would be the case in a traditional acquisition.

Thus, according to an embodiment, the length of the subset may be defined as L_{sub}=k*L_{P}+Lₒᵥₑᵣ, where Lₒᵥₑᵣ is an overlap duration. A taper function of length L_{sub}, where the tapering occurs in the overlapping part, could be suitable in order to obtain a subset with a smooth frequency spectrum and as much energy as one or several repetitions of the original sweep sₙ. Such function W may be defined as follows:

$$W ( t ) = \{ \begin{matrix}{sin}^{2} ( \frac{π}{2} \cdot \frac{t}{{L}_{Over}} ) & if 0 \leq t < {L}_{Over} \\ 1 & if {L}_{Over} \leq t < k * {L}_{S} \\ {cos}^{2} ( \frac{π}{2} \cdot \frac{t - ( k * {L}_{S} )}{{L}_{Over}} ) & if k * {L}_{S} \leq t < {L}_{sub} \\ 0 & otherwise\end{matrix} \qquad ( 5 )$$

where the taper duration is L_{Tap} and the overlap duration is Lₒᵥₑᵣ, which are defined by the user. If a fleet n is ready to emit at a calendar time T, and a basic template p(t) fits in its entirety inside the time interval [T, T+Lₚ], then only the basic template p(t) is emitted. However, if the basic template p(t) does not fully fit inside the above noted time interval, then the vibratory source emits a tapered subset SW of the continuous signal given by:

SW_{n,T}(t)=W(t−T)·cₙ(t) (6)

After the seismic waves generated by the various fleets enter the earth and get reflected and/or refracted by the subsurface, the seismic sensors distributed at the earth's surface or just under the surface record the corresponding seismic data. These signals are processed as follows.

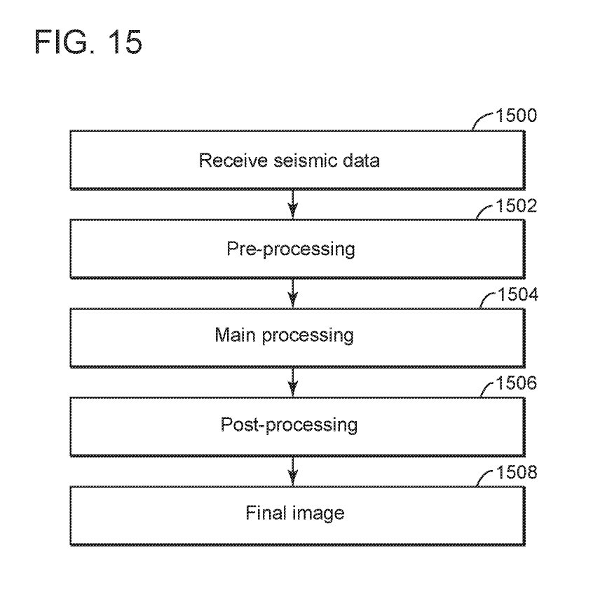

The seismic data may be processed in a corresponding processing device for generating an image of the surveyed subsurface. For example, seismic data generated with the vibratory sources as discussed with regard to FIGS. 11A to 14B may be received in step 1500 of FIG. 15 at the processing device. In step 1502 pre-processing methods are applied, e.g., demultiple, signature deconvolution, trace summing, vibroseis correlation, resampling, etc. In step 1504 the main processing takes place, e.g., deconvolution, amplitude analysis, statics determination, common middle point gathering, velocity analysis, normal move-out correction, muting, trace equalization, stacking, noise rejection, amplitude equalization, etc. In step 1506, final or post-processing methods are applied, e.g. migration, wavelet processing, inversion, etc. In step 1508 the image of the subsurface is generated.

Step 1504 may include, if the emitted signal is a time-shifted version of the basic template p(t), the correlation of the raw recorded seismic data with this basic template p(t) to provide an approximation of the earth reflectivity. However, if the emitted signal is not simply the time-shifted version of the basic template p(t), then the emitted signal S(t) can be split into a low-frequency part S_{L}(t) and a high-frequency part S_{H}(t).

More specifically, let f_{Sover} and f_{Eover} be the instantaneous frequencies of the swept-frequency signal at the end of the start taper and at the start of the end taper (i.e., at times L_{Tap} and L_{Tap}+L_{SW}+L_{Over}). The low- and high-frequency components overlap in the range [f_{Sover}, f_{Eover}].

Let T_{H}(f) and T_{F}(f) be two functions such that:

T_{H}(f)=0 and T_{L}(f)=l if f<f_{Sover},
T_{H}(f)=1 and T_{L}(f)=0 if f>f_{Eover}, and
T_{H}(f)+T_{L}(f)=1 if f_{Sover}≤f≤f_{Sover}.

Let ŝ(f) be the Fourier transform of the template sweep s(t), and Ŝ_{L}(f) and Ŝ_{H}(f) be the Fourier transform of the low- and high-frequency components of the emitted signal.

Two correlation operators that have the phase of the high- and low-frequency components and their amplitude derived from the reference template s(t) may be defined as:

$$\begin{matrix}{\hat{C}}_{H} ( f ) = {T}_{H} ( f ) \cdot \hat{s} ( f ) \cdot \frac{{\hat{S}}_{H} ( f )}{\vert {\hat{S}}_{H} ( f ) \vert} , & ( 7 ) \\ and & \\ {\hat{C}}_{L} ( f ) = {T}_{L} ( f ) \cdot \hat{s} ( f ) \cdot \frac{{\hat{S}}_{L} ( f )}{\vert {\hat{S}}_{L} ( f ) \vert} . & ( 8 )\end{matrix}$$

The correlation of the emitted signal by the sum of these two operators closely approximates the autocorrelation of the reference template.

A computing system 1600 (e.g., module 326 or module 313b discussed in FIG. 3) that is suitable for performing the signal processing and/or source actuation described in the above embodiments may include a server 1601. The computing system (also called controller), may be located on each vibratory source as shown in FIG. 3 or it may be located on a single platform associated with a given fleet. In this last case, the controller drives each vibratory source of the fleet. In one application, the controller drives each vibratory source (i) of a fleet (n) with a same corresponding mother signal MSᵢ. However, it is possible that each vibratory source “i” is driven with the same mother signal MSᵢ.

Server 1601 may include a central processor (CPU) 1602 coupled to a random access memory (RAM) 1604 and to a read-only memory (ROM) 1606. The ROM 1606 may also be other types of storage media to store programs, such as programmable ROM (PROM), erasable PROM (EPROM), etc. The processor 1602 may communicate with other internal and external components through input/output (I/O) circuitry 1608 and bussing 1610, to provide control signals and the like. The processor 1602 carries out a variety of functions as is known in the art, as dictated by software and/or firmware instructions.

The server 1601 may also include one or more data storage devices, including a hard drive 1612, CD-ROM drives 1614, and other hardware capable of reading and/or storing information such as DVD, etc. In one embodiment, software for carrying out the above discussed steps may be stored and distributed on a CD-ROM 1616, removable memory device 1618 or other form of media capable of portably storing information. These storage media may be inserted into, and read by, devices such as the CD-ROM drive 1614, the disk drive 1612, etc. The server 1601 may be coupled to a display 1620, which may be any type of known display or presentation screen, such as LCD displays, LED displays, plasma display, cathode ray tubes (CRT), etc. A user input interface 1622 is provided, including one or more user interface mechanisms such as a mouse, keyboard, microphone, touch pad, touch screen, voice-recognition system, etc.

The server 1601 may be coupled to other computing devices, such as the landline and/or wireless terminals via a network. The server may be part of a larger network configuration as in a global area network (GAN) such as the Internet 1628, which allows ultimate connection to the various landline and/or mobile client devices. The computing device (also called controller) may be implemented on a vehicle that performs a land seismic survey or on a vessel that performs a marine seismic survey.

For example, a system 300 for actuating plural sets of vibratory seismic sources includes a land seismic carrier 310 (e.g., a truck) configured to move with a seismic source and a controller (313b, 1600) located on the land seismic carrier. The controller includes, an interface 1610 for receiving 703 a subset duration time L_{sub}, receiving a tapering function W having a time length of L_{sub}, and receiving a calendar time t_{sweep}. The controller also includes a processor 1602 connected to the interface and configured to calculate a continuous signal Cₙ that is made as a periodic repetition of a template pₙ, wherein the template pₙ includes a swept-frequency signal, compute 706 a product Sₙ of a subset of the continuous signal Cₙ and the tapering function W, wherein the subset of the continuous signal Cₙ starts at the calendar time t_{sweep} and lasts for the duration time L_{sub}, and actuate 708 a set n of the plural sets of vibratory sources at the calendar time t_{sweep}, wherein each vibratory source of the set n of vibratory sources is actuated based on the product Sₙ.

The disclosed embodiments provide a system and a method for actuating sources based on a calendar time. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for actuating plural sets of vibratory seismic sources, the method comprising:
calculating, at a controller, a continuous signal Cₙ that is made as a periodic repetition of a template pₙ, wherein the template pₙ includes a swept-frequency signal;
receiving a subset duration time L_{sub};
receiving a tapering function W having a time length of L_{sub};
receiving a calendar time t_{sweep};
computing, at the controller, a product Sₙ of a subset of the continuous signal Cₙ and the tapering function W, wherein the subset of the continuous signal Cₙ starts at the calendar time t_{sweep} and lasts for the duration time L_{sub}; and
actuating a set n of the plural sets of vibratory sources at the calendar time t_{sweep}, wherein each vibratory source of the set n of vibratory sources is actuated based on the product Sₙ.

2. The method of claim 1, further comprising:
calculating a continuous signal Cₙ for each set n of the plural vibratory sources.

3. The method of claim 2, wherein each continuous signal Cₙ has a corresponding sweep sₙ having a corresponding time length L_{SWn}, amplitude profile Aₙ, frequency profile fₙ, initial phase Φₙ and tapering function Tapₙ.

4. The method of claim 3, further comprising:
receiving N slip-times Tₛₗᵢₚₙ, wherein the slip-time Tₛₗᵢₚₙ is a time delay between a starting time of a first set of vibratory sources and a starting time of the n set of vibratory sources.

5. The method of claim 3, further comprising:
calculating the subset duration time L_{P} as a sum of all N slip-time Tₛₗᵢₚₙ.

6. The method of claim 4, further comprising:
calculating the template pₙ as a sum of a swept frequency signal sₙ and a taper time.

7. The method of claim 6, further comprising:
calculating a time shift τₙ as a sum of all N slip-time Tₛₗᵢₚₙ; and
computing the continuous signal Cₙ by periodically repeating the template pₙ from the time shift τₙ.

8. The method of claim 1, wherein the template pₙ is made of the swept-frequency signal followed by a waiting time.

9. The method of claim 3, wherein the sweep length L_{SWn} is a time interval during which a vibratory source emits a given set of frequencies, a starting frequency of the sweep length being fₛ and an end frequency of the sweep length being fₑ, the record length L_{R} is a time during which seismic sensors record seismic signals originating from the vibratory source, and a taper function makes a smooth transition at the start and end frequencies.

10. A controller for actuating plural sets of vibratory seismic sources, the controller comprising:
an interface for
receiving a subset duration time L_{sub},
receiving a tapering function W having a time length of L_{sub}, and
receiving a calendar time t_{sweep}; and
a processor connected to the interface and configured to,
calculate a continuous signal Cₙ that is made as a periodic repetition of a template pₙ, wherein the template pₙ includes a swept-frequency signal,
compute a product Sₙ of a subset of the continuous signal Cₙ and the tapering function W, wherein the subset of the continuous signal Cₙ starts at the calendar time t_{sweep} and lasts for the duration time L_{sub}, and
actuate a set n of the plural sets of vibratory sources at the calendar time t_{sweep}, wherein each vibratory source of the set n of vibratory sources is actuated based on the product Sₙ.

11. The controller of claim 10, wherein the processor is further configured to:
calculate a continuous signal Cₙ for each set n of the plural vibratory sources.

12. The controller of claim 11, wherein each continuous signal Cₙ has a corresponding sweep sₙ having a corresponding time length L_{SWn}, amplitude profile Aₙ, frequency profile fₙ, initial phase Φₙ and tapering function Tapₙ.

13. The controller of claim 12, wherein the interface is configured to:
receive N slip-times Tₛₗᵢₚₙ, wherein the slip-time Tₛₗᵢₚₙ is a time delay between a starting time of a first set of vibratory sources and a starting time of the n set of vibratory sources.

14. The controller of claim 12, wherein the processor is configured to:
calculate the subset duration time L_{P} as a sum of all N slip-time Tₛₗᵢₚₙ.

15. The controller of claim 13, wherein the processor is configured to:
calculate the template pₙ as a sum of a swept frequency signal sₙ and a taper time.

16. The controller of claim 15, wherein the processor is configured to:
calculate a time shift τₙ as a sum of all N slip-time Tₛₗᵢₚₙ; and
compute the continuous signal Cₙ by periodically repeating the template pₙ from the time shift τₙ.

17. The controller of claim 10, wherein the template pₙ is made of the swept-frequency signal followed by a waiting time.

18. The controller of claim 12, wherein the sweep length L_{SWn} is a time interval during which a vibratory source emits a given set of frequencies, a starting frequency of the sweep length being fₛ and an end frequency of the sweep length being fₑ, the record length L_{R} is a time during which seismic sensors record seismic signals originating from the vibratory source, and a taper function makes a smooth transition at the start and end frequencies.

19. A system for actuating plural sets of vibratory seismic sources, the system comprising:
a land seismic carrier configured to move with a seismic source; and
a controller located on the land seismic carrier,
wherein the controller includes,
an interface for
receiving a subset duration time L_{sub},
receiving a tapering function W having a time length of L_{sub}, and
receiving a calendar time t_{sweep}; and
a processor connected to the interface and configured to,
calculate a continuous signal Cₙ that is made as a periodic repetition of a template pₙ, wherein the template pₙ includes a swept-frequency signal,
compute a product Sₙ of a subset of the continuous signal Cₙ and the tapering function W, wherein the subset of the continuous signal Cₙ starts at the calendar time t_{sweep} and lasts for the duration time L_{sub}, and
actuate a set n of the plural sets of vibratory sources at the calendar time t_{sweep}, wherein each vibratory source of the set n of vibratory sources is actuated based on the product Sₙ.

20. The system of claim 19, wherein the processor is further configured to:
calculate a continuous signal Cₙ for each set n of the plural vibratory sources.
